(19) United States
(12) Patent Application Publication
(10) Pub. No.: US 2011/0117240 A1
(43) Pub. Date: May 19, 2011

(54) Process For Preparing a Fermented Product, and the Product Prepared by the Process

(75) Inventors: Eirik Selmer-Olsen, Son (NO); Ivan Abrahamsen, Gneisveien (NO); Terje Sorhaug, Hellinga (NO)

(73) Assignee: Tine BA, Oslo (NO)

(21) Appl. No.: 11/667,464

(22) PCT Filed: Nov. 14, 2005
(86) PCT No.: PCT/NO2005/000427

§ 371 Date: Oct. 31, 2007

(30) Foreign Application Priority Data
Nov. 15, 2004 (NO) 20044969

(51) Int. Cl. A23C 19/068; A23C 19/02

(52) U.S. Cl. 426/39; 426/34

(57) ABSTRACT

The invention relates to a process for preparing a fermented product of which milk or milk products constitute a substantial part, wherein oleic acid is added during the process. The invention also relates to a product prepared by the process.

The present invention relates to the preparation of a fermented product of which milk or milk products constitute a substantial part. The invention also relates to a product prepared by the process. The invention relates in particular to the addition of monounsaturated fatty acids to the raw material for the fermentation of dairy products, with the object of improving consistency and flavour in low-fat products, and also of rendering bacteria more robust against stress factors to which they are subjected when the said dairy products are consumed.

In the Western World obesity and the occurrence of cardiovascular disease are a growing problem. It follows that there has been a distinct increase in nutrition-related diseases in the Western World. In the last 20-30 years attention has been drawn to the fact that there is a clear connection between the intake of animal fat and the occurrence of cardiovascular disease. As a result of this knowledge, the food industry has in the last 15-20 years developed a number of products, where the objective has been to reduce or replace unhealthy fat with presumed healthier fat sources. For the dairy and meat industries, this has proved to be a major challenge. There have been problems in developing lean products with almost the same flavour as the original whole fat products. For example, the industry has not quite risen to the challenge when it comes to lean cheeses. Typical for lean cheeses is that they have a poor aroma, an undesirable flavour and a consistency which may be characterised as rubbery.

Fermentation involves microbiological transformation and/or breakdown of components in the fermentation medium. Research concerning the understanding of the different fermentations of food where the maturation period is an important factor for the development of the desired quality of the product has primarily been concentrated on carbohydrates and proteins. Where the understanding of the ripening processes in cheeses is concerned, the breakdown of proteins has been a central theme in the research. The proteolysis in cheese and the further transformation of the products of the proteolysis are of great importance for the ripening process in cheese. However, there has been no success in solving the problems related to lean cheeses by solely focussing on proteolysis. Rather surprisingly, there has been little directed research on mechanisms of action between bacteria and fat, and the effect that these mechanisms have on the fermentation process.

A number of different methods to enhance the quality of lean cheeses have been tried. In general, it may be said that attempts have been made to modify most of the cheese-making technical factors such as prematuration, after-heating, temperature of different stores etc. In the last ten years the microorganisms in cheese have become the focus of attention, and in particular the lactic acid bacteria that are not added as a part of the starter culture, but which grow during storage. Attempts have been made to use fat substitutes based on components from milk with differing degrees of success. It has been found difficult to obtain a satisfactory flavour development when using fat substitutes. A common feature of most of these attempts (which are reported in the literature) at solving problems linked to lean cheese is a general focus on individual factors. We know that fat has an effect on bacteria, and we also know that bacteria contribute to the proteolysis in cheese. By subjecting bacteria to specific fatty acids, it will be possible to affect the quality of the cheeses.

Free fatty acids and secondary metabolites such as methyl ketones, lactones, esters and secondary alcohols are of great importance for the flavour of cheese. Butterfat or milk fat is an important ingredient of cheese in order to obtain a good, balanced flavour. Tests have been reported where an attempt has been made to replace butterfat with vegetable fat. In such cases the cheese does not develop a satisfactory flavour. This is because butterfat, unlike vegetable fat, contains a relatively large proportion of short fatty acids: butyric acid (C_{4:0}), caproic acid (C_{6:0}), caprylic acid (C_{8:0}), capric acid (C_{10:0}) and lauric acid (C_{12:0}). The short fatty acids (<12 carbon atoms) have a much stronger characteristic flavour than the long fatty acids (>12 carbon atoms). To obtain the correct flavour and aroma in lean cheeses, it is therefore important to have a presence of short and intermediate fatty acids.

The present invention is based on the addition of emulsified oleic acid and/or fat fractions having a major portion of oleic acid to the cheese milk, which will affect the consistency of the cheese. The enrichment of the cheese milk with oleic acid can come from different sources. Pure oleic acid and/or low-melting fractions of buttermilk (olein fraction) may be used. It is also possible to use buttermilk fractions as the basis for an acid hydrolysis to increase the oleic acid content.

Accordingly, the present invention relates to a process for preparing a fermented product of which milk or milk products constitute a substantial part, wherein the process comprises the following steps:
i) providing a raw material for the fermented product;
ii) optionally adding and mixing into the raw material auxiliary ingredients;
iii) fermenting the product in i) or optionally ii), characterised in that oleic acid is added in step i).

The invention also relates to a process for preparing a fermented product of which milk or milk products constitute a substantial part, wherein the process comprises the following steps:
i) providing a raw material for the fermented product;
ii) optionally adding and mixing into the raw material auxiliary ingredients;
iii) fermenting the product in i) or optionally ii), characterised in that oleic acid is added is added in step ii).

The invention further comprises a process for preparing a fermented product of which milk or milk products constitute a substantial part, wherein the process comprises the following steps:
i) providing a raw material for the fermented product;
ii) optionally adding and mixing into the raw material auxiliary ingredients;
iii) fermenting the product in i) or optionally ii), characterised in that oleic acid is added in step iii).

In addition, the invention relates to a product characterised in that it is prepared by one of the processes according to the invention.

It is important to have a presence of the short and intermediate fatty acids that are found in butterfat. When butterfat or milk fat is fractionated, the low-melting fraction (the olein fraction) contains greater concentrations of short unsaturated fatty acids. In lean cheese tests conducted in connection with the present invention where cheese milk has added to it either a combination of free oleic acid and an olein fraction or the olein fraction alone, it was found that the cheese had a better consistency than the control which contained native butterfat. In a sensory evaluation, the cheeses containing an olein fraction as fat source were chosen in preference to the control cheese as regards consistency.

Different combinations of native butterfat, fractions of butterfat, modified butterfat and different sources of oleic acid can be used as fat source. Apart from native butterfat, the fat/oil sources must be emulsified. The fat/oil source is emulsified using a homogenisor or microfluidiser. Depending on the composition of the fat, temperatures in the range of 15-60° C. and homogenising pressures of between 20-1000 bar are used. If the fat is emulsified in milk, skimmed milk is used which does not contain more than 0.01% original milk fat. It is also appropriate to use buttermilk or components from buttermilk as emulsifier.

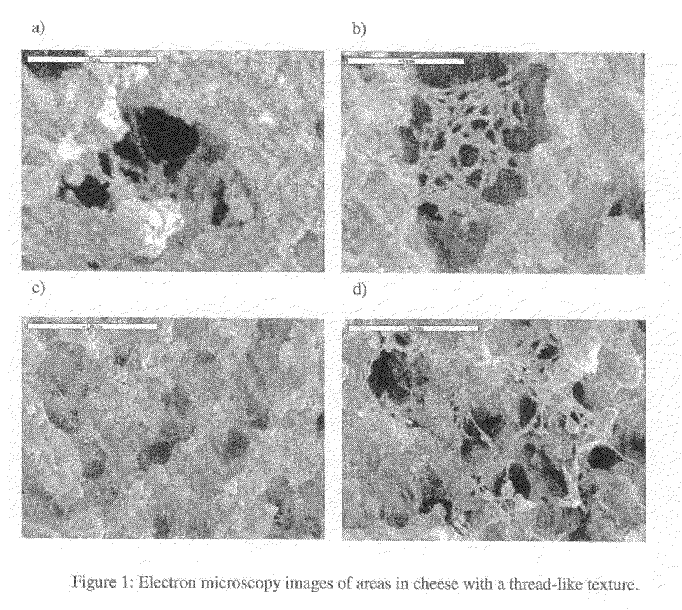

The texture of cheese changes during ripening partly because of proteolysis. During the ripening of cheese, a thread-like network is formed in the matrix. On the basis of electron microscopy images we have taken, it would seem as if the network is found in the liquid layers between fat and the protein matrix in the cheese; see FIG. 1. The extent of the network increases as the ripening process proceeds. Often bacteria are trapped inside or bound to the network. In the literature, these networks are explained by the fact that the bacteria produce extracellular polysaccharides which, because of dehydration during sample processing for electron microscoping, form networks. When bacteria are cultured under the influence of oleic acid, we have registered that an extracellular material is formed, which may be of relevance in relation to the observations that have been made in cheese relating to thread-like material.

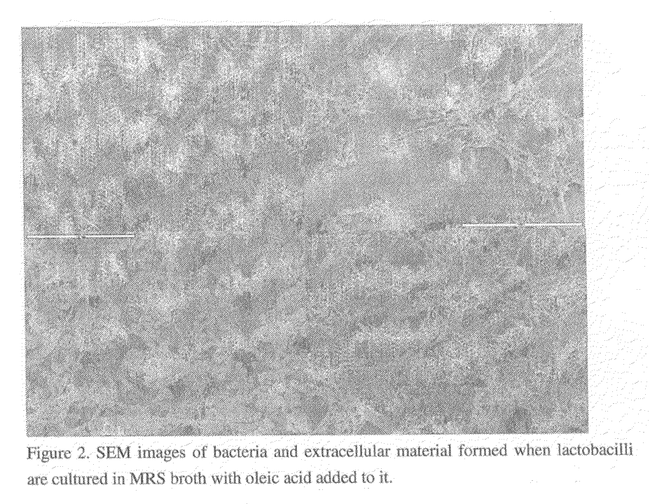

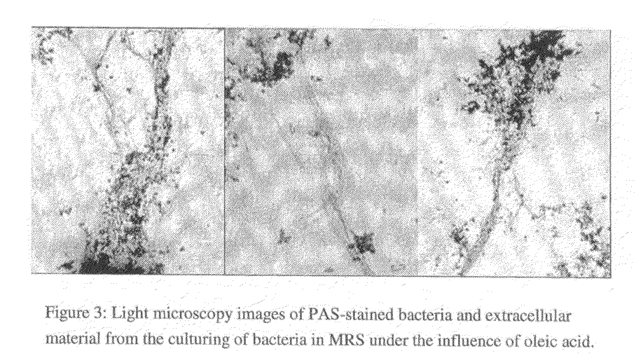

During the culturing of a number of different bacteria (lactococci, lactobacilli and propionic acid) under the influence of oleic acid, we observed that a thread-like material was formed in the medium. As the culture progressed, aggregates were formed wherein bacteria and extracellular material were intertwined; see FIGS. 2 and 3. This suggests that different bacteria react to oleic acid by forming extracellular components. Depending on the bacteria, we have registered extracellular material in the culture medium at oleic acid concentrations of 0.1-12 mM. During the course of the ripening process, the amount of free fatty acids in the cheese increases, and there are great variations in the, concentration depending on the cheese type. The concentration of free oleic acid in cheeses has been reported in the range of 0.05-107 mM.

In addition to the formation of extracellular material that is favourable as regards the consistency of the cheese, the fat fractions having an increased proportion of oleic acid also have an effect on the growth and metabolisation of different bacteria. We made a lean Swiss cheese (17% fat in DM) in which most of the butterfat was replaced by an olein fraction from butterfat having a melting point of 13° C. and pure oleic acid. The microbiological growth and concentration of organic acids in the cheese was affected by the composition of the fat. Table 1 shows the concentration of lactobacilli, lactococci and propionic acid bacteria in the different cheeses after three months' storage. This difference is found again in the concentrations of organic acids which are shown in Table 2. The propionic acid bacteria use lactate as an energy source and consequently there is least lactate in the cheeses with “alien fat” where the concentration of propionic acid bacteria is greatest. It can also be seen from Table 2 that these cheeses have the highest concentration of propionic acid.

By changing the composition of the fat used in the production of cheese, we are able to affect the consistency and flavour of the cheese. The way in which we do this is to increase the proportion of oleic acid in the triglycerides. It is vital that this change takes place without any decrease in the proportion of short and intermediate fatty acids. To obtain the adapted fat for different cheeses, different ratios are used between original butterfat and fractions that are added to increase the oleic acid content. We also affect the consistency and flavour development in the cheese by controlling the emulsification of the fat, both as regards the size of the fat globules and as regards the medium that is used to emulsify the fat.

The invention will be explained in more detail below by means of an example. The example discloses only an embodiment of the present invention, and the invention is therefore not limited to what is given in the example.

Making a lean Swiss type cheese (17% fat in DM) where parts of the butterfat are replaced by a low-melting fraction of butterfat (olein fraction) and free oleic acid.

The olein fraction and the free oleic acid are emulsified in skimmed milk by homogenisation under the conditions of 60 bar and 50° C. The mixture is then pasteurised and added to the cheese milk which has been skimmed and pasteurised beforehand.

The cheese milk should contain 1.5% fat. The fat composition of the cheese milk: 0.2% butterfat, 0.3% oleic acid and 1.0% olein fraction.

The actual cheese making and ripening of the cheese follows conventional technology for making Swiss cheeses.

TABLE 1
The content of propionic acid bacteria, lactobacilli and lactococci in
three-month old lean Swiss cheese with different fat compositions.

| | Propionic acid | Lactobacilli | Lactococci |
|---|---|---|---|
| Fat fraction | bacteria log kde/g | log kde/g | log kde/g |
| Butterfat | 8.43 | 7.0 | 6.52 |
| Olein fraction | 8.80 | 7.5 | 6.3 |
| Olein fraction + | 8.85 | | 6.61 |
| oleic acid | | | |

TABLE 2
Content of organic acids in three-month old lean Swiss cheese with
different fat compositions

| | | Propionic | |
|---|---|---|---|
| Fat fraction | Lactic acid ppm | acid ppm | Acetic acid ppm |
| Butterfat | 18986 | 2856 | 3074 |
| Olein fraction | 19047 | 2972 | 3124 |
| Olein fraction + | 16530 | 4076 | 3298 |
| oleic acid | | | |

1-12. (canceled)

13. A process for preparing a fermented product comprising milk or a milk product, comprising the following steps:
i) obtaining a raw material for the fermented product comprising milk or a milk product;
ii) adding oleic acid to the raw material in a concentration of 0.25-2.5% of the fermented product in step i);
iii) optionally adding and mixing into the raw material auxiliary ingredients; and
iv) fermenting the raw material after step ii) or optionally iii).

14. The process according to claim 13, wherein the oleic acid is added in pure form or as a part of an additive.

15. The process according to claim 13, wherein the oleic acid is added in a concentration of about 1% of the product.

16. The process according to claim 13, wherein the fermented product is a cheese.

17. The process according to claim 16, wherein the fermented product is a Swiss cheese.

18. A process for preparing a fermented product comprising milk or a milk, comprising the following steps:
i) obtaining a raw material for the fermented product comprising milk or a milk product;
ii) adding and mixing auxiliary ingredients and oleic acid to the raw material, wherein said oleic acid is in a concentration of 0.25-2.5% of the product in step i)
iii) fermenting the raw material in step i) or ii).

19. The process according to claim 18, wherein the oleic acid is added in pure form or as a part of an additive.

20. The process according to claim 18, wherein the oleic acid is added in a concentration of about 1% of the product.

21. The process according to claim 18, wherein the fermented product is a cheese.

22. The process according to claim 21, wherein the fermented product is a Swiss cheese.

23. A process for preparing a fermented product comprising milk or a milk, comprising the following steps:
i) obtaining a raw material for the fermented product comprising milk or a milk product;
ii) optionally adding and mixing into the raw material auxiliary ingredients;
iii) fermenting the raw material in step i) or ii);
iv) adding oleic acid in step iii), wherein the oleic acid is add in a concentration of 0.25-2.5% of the product in step i).

24. The process according to claim 23, wherein the oleic acid is added in pure form or as a part of an additive.

25. The process according to claim 23, wherein the oleic acid is added in a concentration of about 1% of the product.

26. The process according to claim 26, wherein the fermented product is a cheese.

27. The process according to claim 27, wherein the fermented product is a Swiss cheese.
